(19) United States
(12) Patent Application Publication
(10) Pub. No.: US 2017/0322158 A1
(43) Pub. Date: Nov. 9, 2017

(54) SPECIMEN DETECTION DEVICE AND SPECIMEN DETECTION CHIP

(71) Applicant: Japan Display Inc., Minato-ku (JP)

(72) Inventors: Masaya TAMAKI, Minato-ku (JP); Kazunori Yamaguchi, Minato-ku (JP); Hiroki Sugiyama, Minato-ku (JP); Masanobu Ikeda, Minato-ku (JP)

(73) Assignee: Japan Display Inc., Minato-ku (JP)

(21) Appl. No.: 15/662,499

(22) Filed: Jul. 28, 2017

Related U.S. Application Data
(62) Division of application No. 14/627,538, filed on Feb. 20, 2015.

(30) Foreign Application Priority Data
Mar. 31, 2014 (JP) 2014-072592

(51) Int. Cl. G01N 21/64

(52) U.S. Cl. CPC G01N 21/6454; G01N 2021/6421

(57) ABSTRACT

According to one embodiment, a specimen detection device includes a light source, a filter, a sensor, and a controller. The light source executes a first operation and a second operation. The first operation causes a first light of a first peak wavelength to be incident on a specimen. The second operation causes a second light of a second peak wavelength to be incident on the specimen. The filter attenuates the first and second lights and transmits at least a portion of a third light and at least a portion of a fourth light. The third light is emitted from the specimen. The fourth light is emitted from the specimen. The sensor outputs a first signal and a second signal. The first signal corresponds to the third. The second signal corresponds to the fourth light. The controller calculates a result value by processing the first and second signals.

### CROSS-REFERENCE TO RELATED APPLICATIONS

The present divisional application claims the benefit of priority under 35 U.S.C. 120 to application Ser. No. 14/627,538, filed on Feb. 20, 2015 and claims the benefit of priority from Japanese Patent Application No. 2014-072592, filed on Mar. 31, 2014; the entire contents of both of which are incorporated herein by reference.

### FIELD

Embodiments described herein relate generally to a specimen detection device and a specimen detection chip.

### BACKGROUND

It is desirable to detect a specimen with high precision in various fields of application such as, for example, medical applications, etc.

### BRIEF DESCRIPTION OF THE DRAWINGS

FIG. 1A and FIG. 1B are schematic views illustrating a specimen detection device according to a first embodiment;

FIG. 2 is a schematic cross-sectional view illustrating a specimen detection chip and a portion of the specimen detection device according to the first embodiment;

FIG. 3 is a graph of characteristics of the specimen detection chip and the specimen detection device according to the first embodiment;

FIG. 4A and FIG. 4B are graphs of characteristics of the specimen detection chip and the specimen detection device according to the first embodiment;

FIG. 5A to FIG. 5D are schematic plan views illustrating specimen detection chips according to a second embodiment;

FIG. 6A and FIG. 6B are schematic views illustrating specimen detection devices according to a third embodiment;

FIG. 7 is a schematic cross-sectional view illustrating a specimen detection chip and a portion of the specimen detection device according to the first embodiment;

FIG. 8 is a schematic cross-sectional view illustrating a portion of the specimen detection device according to the embodiment;

FIG. 9 is a schematic view illustrating a portion of the specimen detection device according to the embodiment; and

FIG. 10 is a schematic plan view illustrating a portion of the specimen detection device according to the embodiment.

### DETAILED DESCRIPTION

According to one embodiment, a specimen detection device includes a light source, a filter, a sensor, and a controller. The light source executes a first operation and a second operation. The first operation causes a first light of a first peak wavelength to be incident on a specimen. The second operation causes a second light of a second peak wavelength different from the first peak wavelength to be incident on the specimen. The filter attenuates the first light and the second light and transmits at least a portion of a third light and at least a portion of a fourth light. The third light is emitted from the specimen irradiated with the first light. The fourth light is emitted from the specimen irradiated with the second light. The sensor outputs a first signal and a second signal. The first signal corresponds to the at least a portion of the third light passing through the filter. The second signal corresponds to the at least a portion of the fourth light passing through the filter. The controller acquires the first signal and the second signal and calculates a result value by processing the first signal and the second signal.

According to one embodiment, a specimen detection chip includes a sensor, a wall unit, and a filter. The sensor includes a plurality of detection elements. The wall unit is separated from the sensor along a stacking direction. The filter is provided between the sensor and the wall unit. The filter attenuates a first light of a first peak wavelength and transmits a light of a wavelength longer than the first peak wavelength. The plurality of detection elements are arranged at a first pitch along a first direction intersecting the stacking direction. The wall unit partitions a plurality of spaces capable of containing a specimen. The plurality of spaces are arranged at a second pitch along the first direction. The second pitch is not less than 0.95 times and not more than 1.05 times an integer multiple of the first pitch.

Various embodiments will now be described hereinafter with reference to the accompanying drawings.

The disclosure is but an example; and appropriate modifications within the spirit of the invention will be readily apparent to one skilled in the art and naturally are within the scope of the invention. Moreover, although the widths, thicknesses, configurations, etc., of components in the drawings may be illustrated schematically compared to the actual embodiments for better clarification of description, these are merely examples and do not limit the construction of the invention.

Further, in the specification and the drawings, components similar to those described in regard to a drawing thereinabove are marked with like reference numerals, and a detailed description may be omitted as appropriate.

### First Embodiment

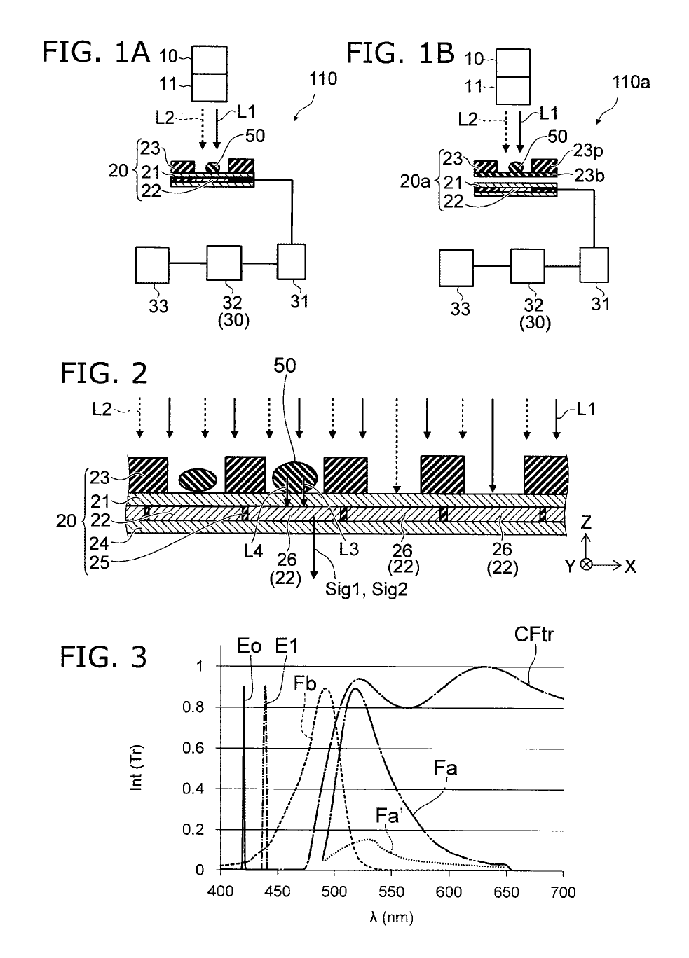

FIG. 1A and FIG. 1B are schematic views illustrating a specimen detection device according to a first embodiment.

As shown in FIG. 1A, the specimen detection device 110 according to the embodiment includes a light source 10, a band-pass filter 11, a filter 21, a sensor 22, and a controller 30.

The light source 10 executes a first operation and a second operation. In the first operation, light that is irradiated from the light source 10 passes through the band-pass filter 11; and a first light L1 of a first peak wavelength is incident on a specimen 50. In the second operation, the light that is irradiated from the light source 10 passes through the band-pass filter 11; and a second light L2 of a second peak wavelength is incident on the specimen 50. The second peak wavelength is different from the first peak wavelength.

The specimen 50 is a substance to be detected by the specimen detection device 110. The specimen 50 is, for example, an organic substance or an inorganic substance. The specimen 50 is, for example, an organic substance that is detected in medical applications, etc. The specimen 50 includes, for example, DNA, antibodies, cells, etc. For example, the specimen 50 is fluorescence-labeled. Light is emitted from the specimen 50 when excitation light is irradiated on the specimen 50. The light is, for example, fluorescence (including phosphorescence).

The first light L1 and the second light L2 are excitation light. The first light L1 and the second light L2 are, for example, ultraviolet. Examples of the first light L1 and the second light L2 are described below.

A third light is emitted from the specimen 50 irradiated with the first light L1. A fourth light is emitted from the specimen 50 irradiated with the second light L2. The peak wavelength of the third light is different from the first peak wavelength. The peak wavelength of the fourth light is different from the second peak wavelength. For example, the peak wavelength of the third light is longer than the first peak wavelength. For example, the peak wavelength of the fourth light is longer than the second peak wavelength.

A specimen detection chip 20 is used in the example. In the example, the specimen detection chip 20 includes a wall unit 23, the filter 21, and the sensor 22. The filter 21 is disposed between the wall unit 23 and the sensor 22. A space is partitioned by the wall unit 23. The specimen 50 is disposed in the space.

The first light L1, the second light L2, the third light, and the fourth light are incident on the filter 21. The filter 21 attenuates the first light L1 and the second light L2. The filter 21 is at least one of absorptive or reflective to the first light L1. The filter 21 is at least one of absorptive or reflective to the second light L2. The filter 21 transmits at least a portion of the third light and at least a portion of the fourth light. For example, the transmittance of the filter 21 has wavelength dependence.

The filter 21 is, for example, an absorption filter. For example, the filter 21 may be a reflection (interference) filter.

For example, the first light L1 and the second light L2 are substantially blocked by the filter 21. The third light and the fourth light that pass through the filter 21 are incident on the sensor 22. Slight amounts of the first light L1 and the second light L2 that could not be blocked by the filter 21 may pass through and be incident on the sensor 22.

The sensor 22 outputs signals corresponding to the light that is incident. Namely, the sensor 22 outputs a first signal corresponding to at least a portion of the third light passing through the filter 21. The sensor 22 outputs a second signal corresponding to at least a portion of the fourth light passing through the filter 21. These signals correspond to the intensity of the light (e.g., the fluorescence) emitted from the specimen 50.

The controller 30 acquires the first signal and the second signal and calculates the result value by processing the first signal and the second signal. The result that is calculated corresponds to the detection result. The controller 30 includes, for example, a calculator 32 (a computer, etc.).

A signal processor 31 and an output unit 33 are provided in the example. The signal processor 31 processes the signal output from the sensor 22. For example, the signal processor 31 amplifies the signal output from the sensor 22. For example, the signal that is amplified is supplied to the controller 30. For example, in the case where the signal that is output from the sensor 22 is an analog signal, the signal processor 31 performs AD conversion. For example, the AD-converted signal that is supplied to the controller 30. The controller 30 calculates the result value using the signal that is supplied.

In the embodiment, at least a portion of the function of the signal processor 31 may be provided in the specimen detection chip 20.

For example, the output unit 33 outputs the result value calculated by the controller 30. The output includes, for example, at least one of transmitting data, printing, or displaying.

In the embodiment, for example, the controller 30 may cause the light source 10 to execute the first operation and the second operation recited above. In other words, the controller 30 may control the operation of the device.

As shown in FIG. 1B, a specimen detection chip 20a is used in a specimen detection device 110a. The wall unit 23 can be separated from the filter 21 in the specimen detection chip 20a. The specimen 50 that is contained in the space partitioned by the wall unit 23 also is separated from the filter 21.

In the example, the wall unit 23 includes a base 23b and a protrusion 23p. The space (the recess) is partitioned by the protrusion 23p and the base 23b. The specimen 50 is contained in the space.

In the specimen detection device 110a, the operations of the light source 10, the filter 21, the sensor 22, and the controller 30 are similar to the operations described in regard to the specimen detection device 110. In the specimen detection devices 110 and 110a, high precision is obtained by calculating the result value by processing the light produced by light (excitation light) of multiple wavelengths. Examples of the processing are described below.

FIG. 2 is a schematic cross-sectional view illustrating a specimen detection chip and a portion of the specimen detection device according to the first embodiment.

FIG. 2 illustrates the specimen detection chip 20. As illustrated in FIG. 2, the direction from the sensor 22 toward the filter 21 is taken as a Z-axis direction. One direction perpendicular to the Z-axis direction is taken as an X-axis direction. A direction perpendicular to the Z-axis direction and the X-axis direction is taken as a Y-axis direction.

As shown in FIG. 2, a plurality of the detection elements 26 are provided on a substrate 24. The plural detection elements 26 are included in the sensor 22. For example, the sensor 22 (the detection elements 26) converts the light into electrical signals. The sensor 22 (the detection elements 26) may include, for example, photoelectric conversion elements. An element separation unit 25 is provided between the plural detection elements 26. For example, interconnects described below are provided in the element separation unit 25. An insulating layer may be provided in the element separation unit 25.

The filter 21 is provided on the sensor 22 (the plural detection elements 26). The filter 21 may include, for example, a dielectric multilayer film. Multiple first layers and multiple second layers are stacked alternately in the dielectric multilayer film. The refractive index of the second layer is different from the refractive index of the first layer. The filter 21 may include a material that absorbs light.

The wall unit 23 is provided on the filter 21. For example, the wall unit 23 includes multiple portions when the wall unit 23 is cut by a plane including the Z-axis direction. The specimen 50 is placed in the spaces enclosed with the multiple portions.

In the first operation, the first light L1 of the first peak wavelength is incident on the specimen 50. In the second operation, the second light L2 of the second peak wavelength is incident on the specimen 50. A third light L3 is emitted from the specimen 50 irradiated with the first light L1. A fourth light L4 is emitted from the specimen 50 irradiated with the second light L2.

The first light L1 and the second light L2 are attenuated by the filter 21. On the other hand, at least a portion of the third light L3 and at least a portion of the fourth light L4 pass through the filter 21. These portions of light are incident on the sensor 22.

The sensor 22 outputs a first signal Sig1 corresponding to the at least a portion of the third light L3 passing through the filter 21. The sensor 22 outputs a second signal Sig2 corresponding to the at least a portion of the fourth light L4 passing through the filter 21. These signals are supplied to the controller 30. At this time, the result of the processing by the signal processor 31 is supplied to the controller 30 as necessary.

FIG. 3 is a graph of characteristics of the specimen detection chip and the specimen detection device according to the first embodiment.

This figure illustrates characteristics of the light emitted from the light source 10, characteristics of the light emitted from the specimen 50, and characteristics of the filter 21. The horizontal axis is a wavelength λ (nm). The vertical axis is an intensity Int or a transmittance Tr of the light. The vertical axis has arbitrary units.

As illustrated in FIG. 3, the light (excitation light E0) that is emitted from the light source has, for example, a wavelength distribution having a peak configuration. For example, in the case where the specimen 50 is processed using a first fluorescent reagent, the characteristics of fluorescence Fa (a fluorescent spectrum) and excitation light Fb (an excitation light spectrum) are obtained. For example, in the case where the first excitation light E0 is irradiated on the specimen 50, fluorescence Fa′ is emitted from the specimen 50. In the case where a second excitation light E1 is irradiated on the specimen 50, the fluorescence Fa that is from the specimen 50 is emitted with an intensity different from the case where the first excitation light E0 is irradiated. The characteristics of the fluorescence are dependent on the type of specimen 50 and the type of reagent. A transmittance CFtr of the filter 21 for the excitation light E0 is low. On the other hand, the transmittance CFtr of the filter 21 for the fluorescence Fa is high. Thus, by using the filter 21 that attenuates the excitation light and transmits at least a portion of the fluorescence, the fluorescence Fa that is the object of the detection can be detected efficiently. Thereby, the precision of the detection increases.

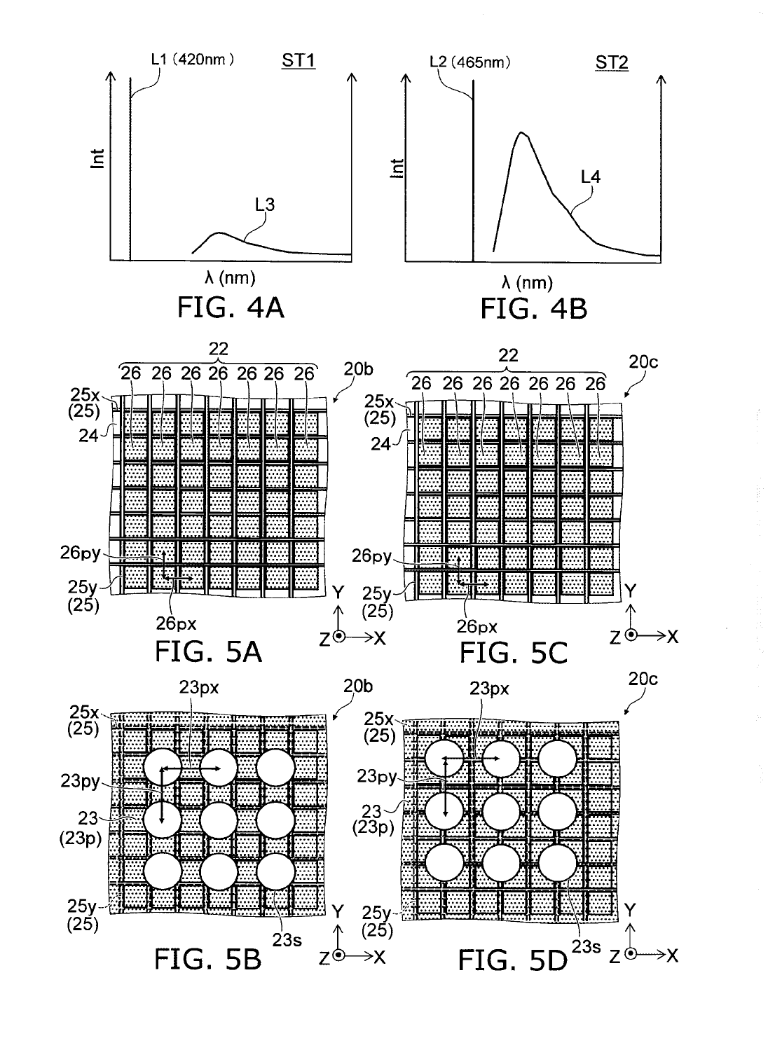

FIG. 4A and FIG. 4B are graphs of characteristics of the specimen detection chip and the specimen detection device according to the first embodiment.

FIG. 4A illustrates a first operation ST1. FIG. 4B illustrates a second operation ST2. In these figures, the horizontal axis is the wavelength λ; and the vertical axis is the intensity Int. In the example, a first fluorescent reagent is used.

In the first operation ST1 as shown in FIG. 4A, the first light L1 is emitted from the light source 10 via the band-pass filter 11. In the example, the peak wavelength of the first light L1 is about 420 nm. At this time, the third light L3 is emitted from the specimen 50. The intensity Int of the third light L3 is relatively low.

In the second operation ST2 as shown in FIG. 4B, the second light L2 is emitted from the light source 10 via the band-pass filter 11. In the example, the peak wavelength of the second light L2 is about 465 nm. At this time, the fourth light L4 is emitted from the specimen 50. The intensity Int of the fourth light L4 is relatively high.

Thus, multiple excitation light of different wavelengths is irradiated on the specimen 50. The intensity of each of the multiple fluorescence obtained at this time are different from each other. The ratio of the intensities of the multiple fluorescence is unique to, for example, the material of the specimen 50. High-precision detection is possible by using this ratio as the result value.

For example, a first value V1 is a value corresponding to the first signal Sig1. A second value V2 is a value corresponding to the second signal Sig2. For example, a value corresponding to the ratio (i.e., V1/V2) of the first value V1 to the second value V2 is used as the result value. A value corresponding to V2/V1 may be used as the result value. For example, the product of this ratio and a constant may be used as the result value.

For the specimen 50 of one material, the ratio of the intensity of the third light L3 emitted based on the first light L1 to the intensity of the fourth light L4 emitted based on the second light L2 is unique in the case where the concentration of the fluorescent reagent, the intensity of the light, the transmission distance of the light, etc., are unchanged. Therefore, high-precision detection is possible by using this ratio.

For example, there is a reference example in which the specimen 50 is detected using only light of one wavelength. In such a case, light emission due to autofluorescence exists for an object (a specimen) that is not fluorescence-labeled. There are cases where erroneous detection occurs due to the effects of the autofluorescence. Therefore, in such a reference example, the precision of the detection is low.

Conversely, in the embodiment, the detection is performed using light of multiple wavelengths. In such a case, the ratio (e.g., V1/V2, etc.) of the light emission that is obtained is unique to the fluorescence-labeled specimen 50. Thereby, the effects of the autofluorescence are suppressed.

For example, in medical applications, there is a reference example in which a fluorescence microscope is used when detecting the fluorescence-labeled specimen 50 (DNA, antibodies, cells, etc.). A complex optical system is used in such a reference example. Therefore, the device size is large. For example, it is difficult to perform the measurement at the patient's bedside.

Conversely, the specimen detection device according to the embodiment is compact. Thereby, a POCT (Point of Care Test) is easy.

For example, in the embodiment, the specimen detection chip 20 (or 20a) is disposable. For example, one specimen detection chip is used for one detection.

For example, the filter 21 is formed on the sensor 22. The wall unit 23 may be formed on the filter 21. For example, the wall unit 23 may be attached to the filter 21.

In the embodiment, the first peak wavelength is, for example, 420 nanometers or less. The second peak wavelength is longer than 420 nanometers. Thereby, it is easy to effectively obtain two fluorescences having high intensity. In the embodiment, the first peak wavelength and the second peak wavelength are arbitrary.

In the embodiment, calibration of the detection may be performed. For example, there are cases where dark current, etc., exist in the sensor 22. The sensitivity of the detection can be increased further by considering the signal corresponding to the dark current.

For example, the controller 30 may further execute the third operation and the fourth operation described below. In these operations, the detection of the light is performed in a state in which the specimen 50 is not placed in the space defined by the wall unit 23.

For example, in the third operation, the controller 30 causes the first light L1 to be incident on the sensor 22 without passing through the specimen 50. Then, the controller 30 causes the sensor 22 to output a first reference signal corresponding to the first light L1 not passing through the specimen 50.

For example, in the fourth operation, the controller 30 causes the second light L2 to be incident on the sensor 22 without passing through the specimen 50. Then, the controller 30 causes the sensor 22 to output a second reference signal corresponding to the second light L2 not passing through the specimen 50.

The controller 30 calculates the result value by processing the first signal Sig1 and the second signal Sig2 by using a value corresponding to the first reference signal and a value corresponding to the second reference signal.

Thereby, correction can be performed based on the difference between the signals with and without the specimen 50. For example, the correction can be performed based on a characteristic (e.g., dark current, etc.) that is unique to the sensor 22. For example, the third operation and the fourth operation recited above are performed before the specimen 50 is placed in the specimen detection chip 20 (or 20a). Then, the first operation ST1 and the second operation ST2 recited above are executed in the state in which the specimen 50 is placed in the specimen detection chip 20 (or 20a). Then, the correction is performed using the reference signal. For example, correction based on a characteristic that is unique to the specimen detection chip 20 (or 20a) also may be executed.

In the embodiment, the correction may be performed by detecting the light obtained in the state in which the excitation light is not irradiated on the specimen 50, and performing the correction based on the result. For example, in the fifth operation, the controller 30 causes the sensor 22 to output the third reference signal without causing the light source 10 to emit the first light L1 and the second light L2. The third reference signal includes, for example, the dark current of the sensor 22. When the light that is emitted from the specimen 50 is detected by the sensor 22, the third reference signal at this time includes, for example, a component of the autofluorescence produced by the specimen 50. At this time, the controller 30 calculates the result value by processing the first signal Sig1 and the second signal Sig2 using a value corresponding to the third reference signal. Thereby, detection having even higher precision is possible.

At least one of the first operation or the second operation recited above may be executed multiple times. For example, the results of the operation executed multiple times may be summed.

For example, the light source 10 executes the first operation ST1 multiple times. The sensor 22 outputs the multiple first signals Sig1 corresponding to the first operations ST1 of the multiple times. The controller 30 calculates the result value based on the result of the multiple first signals Sig1 acquired.

For example, the light source 10 executes the second operation ST2 multiple times. The sensor 22 outputs the multiple second signals Sig2 corresponding to the second operations ST2 of the multiple times. The controller 30 calculates the result value based on the result of the multiple second signals Sig2 acquired.

Thus, high-precision detection can be executed stably by calculating the result value based on the results of executing the operation multiple times.

### Second Embodiment

FIG. 5A to FIG. 5D are schematic plan views illustrating specimen detection chips according to a second embodiment.

FIG. 5A and FIG. 5B illustrate a specimen detection chip 20b according to the embodiment. FIG. 5A illustrates the sensor 22. FIG. 5B illustrates the wall unit 23 and plural spaces 23s. As described above, the sensor 22 and the wall unit 23 overlap. In these drawings, the sensor 22 and the wall unit 23 are shown separately for easier viewing of the drawings. The filter 21 is not shown in these drawings.

As shown in FIG. 5A, the sensor 22 is provided in the specimen detection chip 20b according to the embodiment. As shown in FIG. 5B, the wall unit 23 is provided in the specimen detection chip 20b according to the embodiment.

The sensor 22 includes a plurality of the detection elements 26. The plural detection elements 26 are arranged at a first pitch 26px along the first direction (e.g., the X-axis direction). The first direction intersects the stacking direction (e.g., the Z-axis direction). The element separation unit 25 is provided in between detection elements 26. The element separation unit 25 includes plural first interconnects 25x and plural second interconnects 25y. The first interconnects 25x extend in the X-axis direction. The second interconnects 25y extend in the Y-axis direction.

The wall unit 23 is separated from the sensor 22 along the stacking direction. The wall unit 23 partitions the plural spaces 23s capable of containing the specimen 50. The plural spaces 23s are arranged at a second pitch 23px along the first direction (e.g., the X-axis direction).

As illustrated in FIG. 1A and FIG. 1B, the filter 21 is provided between the sensor 22 and the wall unit 23. The filter 21 attenuates the first light L1 of the first peak wavelength. The filter 21 transmits light of wavelengths longer than the first peak wavelength. The filter 21 attenuates the second light L2 of the second peak wavelength. The filter 21 transmits light of wavelengths longer than the second peak wavelength.

The second pitch 23px is substantially an integer multiple of the first pitch 26px. For example, the second pitch 23px is not less than 0.95 times and not more than 1.05 times an integer multiple of the first pitch 26px.

In the example, the second pitch 23px is substantially twice first pitch 26px. For example, the second pitch 23px is not less than 0.95 times and not more than 1.05 times twice the first pitch 26px.

In the example, the plural detection elements 26 are further arranged at a third pitch 26py along the second direction (e.g., the Y-axis direction). The second direction intersects the first direction and the stacking direction.

The plural spaces 23s are further arranged at a fourth pitch 23py along the second direction.

The fourth pitch 23py is substantially an integer multiple of the third pitch 26py. For example, the fourth pitch 23py is not less than 0.95 times and not more than 1.05 times an integer multiple of the third pitch 26py. For example, the fourth pitch 23py is substantially twice the third pitch 26py. For example, the fourth pitch 23py is not less than 0.95 times and not more than 1.05 times twice the third pitch 26py.

Thus, in the embodiment, the pitch of the multiple detection elements 26 is set to substantially an integer multiple of the pitch of the multiple spaces 23s. Thereby, for example, the detection elements 26 overlap the spaces 23s even in the case where the positions of the multiple detection elements 26 are shifted from the positions of the multiple spaces 23s. The position of the specimen 50 placed in the spaces 23s overlaps the detection elements 26. Thereby, high-precision detection can be performed.

For example, a length along the first direction of each of the multiple spaces 23s is not less than the length along the first direction of each of the plural detection elements 26. For example, the length along the second direction of each of the multiple spaces 23s is not less than the length along the second direction of each of the plural detection elements 26.

Thereby, it is easy for the positions of the spaces 23s to overlap the positions of the detection elements 26. Thereby, high-precision detection is possible.

FIG. 5C and FIG. 5D illustrate a specimen detection chip 20c according to the embodiment. FIG. 5C illustrates the sensor 22. FIG. 5D illustrates the wall unit 23 and the plural spaces 23s. The sensor 22 and the wall unit 23 are shown separately in these drawings. The filter 21 is not shown in these drawings.

In the specimen detection chip 20c according to the embodiment as shown in FIG. 5C and FIG. 5D, four detection elements 26 overlap one space 23s. For example, one of the plural spaces 23s overlaps at least two of the plural detection elements 26 when projected onto the X-Y plane (the plane perpendicular to the stacking direction). The space 23s may overlap three or detection elements 26. In the case where one space 23s overlaps multiple detection elements 26, high-precision detection is possible by processing the signal obtained by the plural overlapping detection elements 26.

For example, detection elements 26 that do not overlap the spaces 23s may be provided. The light that is emitted from the specimen 50 substantially is not incident on such detection elements 26. The precision of the detection is increased by performing the processing using the signal obtained from such detection elements 26.

In the embodiment, as described in regard to FIG. 1B, the wall unit 23 may include the base 23b and the protrusion 23p. The base 23b is disposed between the protrusion 23p and the filter 21. For example, the multiple spaces 23s are partitioned by the base 23b and the protrusion 23p. The wall unit 23 is, for example, a well substrate. For example, the base 23b may be separated from the filter 21. For example, the base 23b may contact the filter 21. The wall unit 23 may be separated from the filter 21 or may contact the filter 21.

### Third Embodiment

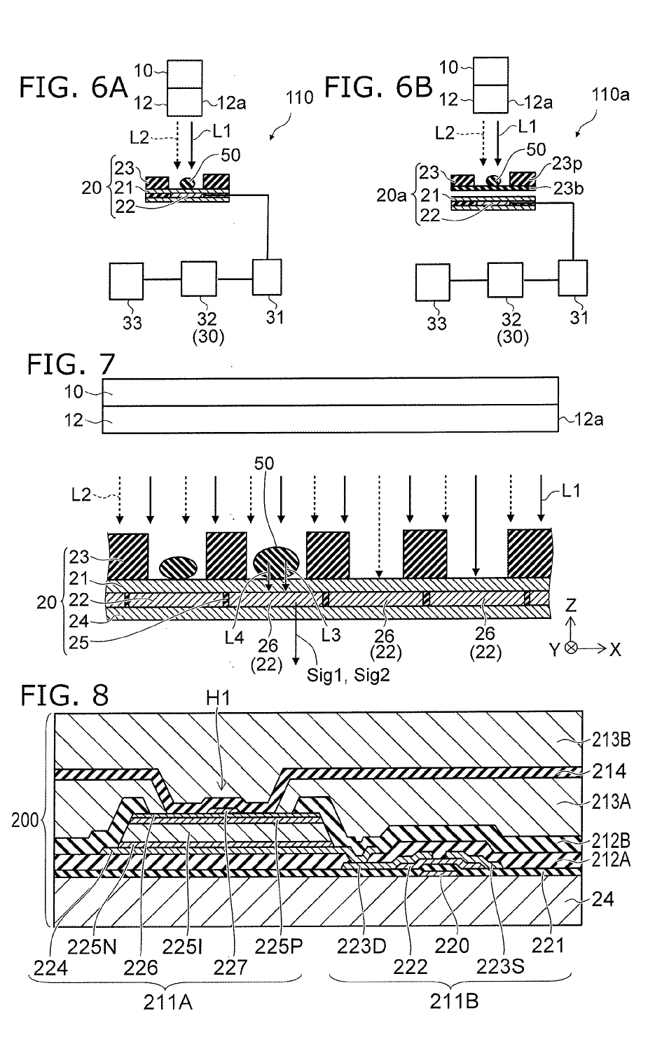

FIG. 6A and FIG. 6B are schematic views illustrating specimen detection devices according to a third embodiment.

As shown in FIG. 6A, a specimen detection device 110 according to the embodiment includes the light source 10, an optical element unit 12, the filter 21, the sensor 22, and the controller 30. The optical element unit 12 includes, for example, a diffraction grating.

The light source 10 emits light. The optical element unit 12 is provided between the light source 10 and the sensor 22. The light source 10 produces the first light L1 of the first peak wavelength and the second light L2 of the second peak wavelength via the optical element unit 12. The second peak wavelength is different from the first peak wavelength. It is desirable for the full width at half maximum of the first light L1 to be, for example, 1 nanometer (nm) or less. It is desirable for the full width at half maximum of the second light L2 to be, for example, 1 nm or less. The first light L1 and the second light L2 that are produced are irradiated on the specimen 50.

The third light is emitted from the specimen 50 on which the first light L1 is irradiated. The fourth light is emitted from the specimen 50 on which the second light L2 is irradiated. The peak wavelength of the third light is different from the first peak wavelength. The peak wavelength of the fourth light is different from the second peak wavelength. For example, the peak wavelength of the third light is longer than the first peak wavelength. For example, the peak wavelength of the fourth light is longer than the second peak wavelength.

The specimen detection chip 20 is used in the example. In the example, the wall unit 23, the filter 21, and the sensor 22 are provided in the specimen detection chip 20. The filter 21 is disposed between the wall unit 23 and the sensor 22. The space is partitioned by the wall unit 23. The specimen 50 is disposed in the space.

The first light L1, the second light L2, the third light L3, and the fourth light L4 are incident on the filter 21. The filter 21 attenuates the first light L1 and the second light L2. The filter 21 is at least one of absorptive or reflective to the first light L1. The filter 21 is at least one of absorptive or reflective to the second light L2. The filter 21 transmits at least a portion of the third light and at least a portion of the fourth light. For example, the transmittance of the filter 21 has wavelength dependence.

The filter 21 is, for example, an absorption filter. The filter 21 may be, for example, a reflection (interference) filter.

For example, the first light L1 and the second light L2 are substantially blocked by the filter 21. The third light L3 and the fourth light L4 pass through the filter 21 and are incident on the sensor 22. Slight amounts of the first light L1 and the second light L2 that could not be blocked by the filter 21 may pass through and be incident on the sensor 22.

The sensor 22 outputs signals corresponding to the light that is incident. Namely, the sensor 22 outputs the first signal corresponding to at least a portion of the third light L3 passing through the filter 21. The sensor 22 outputs the second signal corresponding to at least a portion of the fourth light L4 passing through the filter 21. These signals correspond to the intensity of the light (e.g., the fluorescence) emitted from the specimen 50.

The controller 30 acquires the first signal and the second signal and calculates a result value by processing the first signal and the second signal. The result that is calculated corresponds to the detection result.

As shown in FIG. 6B, the specimen detection device 110a includes the specimen detection chip 20a. The wall unit 23 is separated from the filter 21 in the specimen detection chip 20a. The specimen 50 that is placed in the space partitioned by the wall unit 23 also is separated from the filter 21. The optical element unit 12 is provided between the light source 10 and the specimen detection chip 20a.

In the specimen detection device 110a, the operations of the light source 10, the optical element unit 12, the filter 21, the sensor 22, and the controller 30 are similar to the operations described in regard to the specimen detection device 110. In the specimen detection devices 110 and 110a, high precision is obtained by calculating the result value by processing the light produced using the light (the excitation light) of multiple wavelengths.

FIG. 7 is a schematic cross-sectional view illustrating a specimen detection chip and a portion of the specimen detection device according to the first embodiment.

FIG. 7 illustrates the specimen detection chip 20. As illustrated in FIG. 7, the direction from the sensor 22 toward the optical element unit 12 is taken as the Z-axis direction. One direction perpendicular to the Z-axis direction is taken as the X-axis direction. A direction perpendicular to the Z-axis direction and the X-axis direction is taken as the Y-axis direction.

As shown in FIG. 7, the plural detection elements 26 are provided on the substrate 24. The plural detection elements 26 are included in the sensor 22. For example, the sensor 22 (the detection elements 26) converts the light into electrical signals. The element separation unit 25 is provided between the plural detection elements 26. For example, the interconnects described below are provided in the element separation unit 25. An insulating layer may be provided in the element separation unit 25.

The filter 21 is provided on the sensor 22 (the plural detection elements 26). The filter 21 may include, for example, a dielectric multilayer film. Multiple first layers and multiple second layers are stacked alternately in the dielectric multilayer film. The refractive index of the second layer is different from the refractive index of the first layer. The filter 21 may include a material that absorbs the light.

The wall unit 23 is provided on the filter 21. For example, the wall unit 23 includes multiple portions when the wall unit 23 is cut by a plane including the Z-axis direction. The specimen 50 is contained in the spaces enclosed with the multiple portions.

The first light L1 that is produced from the optical element unit 12 is incident on the specimen 50. The second light L2 that is produced from the optical element unit 12 is incident on the specimen 50. The third light L3 is emitted from the specimen 50 irradiated with the first light L1. The fourth light L4 is emitted from the specimen 50 irradiated with the second light L2.

The first light L1, the second light L2, the third light L3, and the fourth light L4 are incident on the filter 21. The filter 21 attenuates the first light L1 and the second light L2. The filter 21 is at least one of absorptive or reflective to the first light L1. The filter 21 is at least one of absorptive or reflective to the second light L2. The filter 21 transmits at least a portion of the third light and at least a portion of the fourth light. For example, the transmittance of the filter 21 has wavelength dependence.

The filter 21 is, for example, an absorption filter. The filter 21 may be, for example, a reflection (interference) filter.

For example, the first light L1 and the second light L2 are substantially blocked by the filter 21. The third light L3 and the fourth light L4 that pass through the filter 21 are incident on the sensor 22. Slight amounts of the first light L1 and the second light L2 that could not be blocked by the filter 21 may pass through and be incident on the sensor 22.

The sensor 22 outputs the first signal Sig1 corresponding to at least a portion of the third light L3 emitted from the specimen 50. The sensor 22 outputs the second signal Sig2 corresponding to at least a portion of the fourth light L4 emitted from the specimen 50. These signals are supplied to the controller 30. At this time, the result that is processed by the signal processor 31 is supplied to the controller 30 as necessary.

An example of the sensor 22 will now be described.

FIG. 8 is a schematic cross-sectional view illustrating a portion of the specimen detection device according to the embodiment.

FIG. 8 illustrates a sensor substrate 200. FIG. 8 illustrates a line A1-A2 cross section of FIG. 10 described below.

As shown in FIG. 8, multiple photodiodes 211A (photoelectric conversion elements) and thin film transistors 211B are provided on the substrate 24. For example, the thin film transistor 211B drives the photodiode 211A. The substrate 24 includes, for example, a glass substrate.

The thin film transistor 211B includes a gate insulator film 221. The gate insulator film 221 is provided on the substrate 24. A first inter-layer insulating film 212A is provided on the gate insulator film 221.

For example, a PIN diode is used as the photodiode 211A. In the example, the photodiode 211A includes a lower electrode 224, an n-type semiconductor layer 225N, an i-type semiconductor layer 225I, a p-type semiconductor layer 225P, an upper electrode 226, and an interconnect layer 227. The lower electrode 224 is provided on the first inter-layer insulating film 212A. The n-type semiconductor layer 225N is provided on the lower electrode 224. The i-type semiconductor layer 225I is provided on the n-type semiconductor layer 225N. The p-type semiconductor layer 225P is provided on the i-type semiconductor layer 225I. The upper electrode 226 is provided on the p-type semiconductor layer 225P. The interconnect layer 227 is electrically connected to the upper electrode 226.

For example, the lower electrode 224 reads the signal charge from the photoelectric conversion layer (the n-type semiconductor layer 225N, the i-type semiconductor layer 225I, and the p-type semiconductor layer 225P). For example, amorphous silicon is used as the n-type semiconductor layer 225N. The n-type semiconductor layer 225N includes, for example, an n⁺-region. For example, amorphous silicon is used as the i-type semiconductor layer 225I. For example, amorphous silicon is used as the p-type semiconductor layer 225P. For example, the p-type semiconductor layer 225P includes a p⁺-region. For example, a light-transmissive conductive film is used as the upper electrode 226. For example, the upper electrode 226 supplies a reference potential (a bias potential) to the photoelectric conversion layer.

For example, a field effect transistor is used as the thin film transistor 211B. The thin film transistor 211B includes a gate electrode 220, a semiconductor layer 222, a source electrode 223S, and a drain electrode 223D. The gate electrode 220 is provided on the substrate 24. The gate insulator film 221 is provided on the gate electrode 220. The semiconductor layer 222 is provided on the gate insulator film 221. The source electrode 223S and the drain electrode 223D are provided on the semiconductor layer 222. For example, polycrystalline silicon, microcrystalline silicon, or amorphous silicon is used as the semiconductor layer 222. For example, an oxide semiconductor may be used as the semiconductor layer 222. The drain electrode 223D is connected to the lower electrode 224.

The sensor substrate 200 includes a second inter-layer insulating film 212B, a first planarization film 213A, a protective film 214, and a second planarization film 213B. The second inter-layer insulating film 212B covers the side surface of the photodiode 211A and the side surface of the thin film transistor 211B. The first planarization film 213A is provided on the thin film transistor 211B and on a portion of the photodiode 211A. An opening H1 is provided in the first planarization film 213A. The protective film 214 is provided on the upper electrode 226, on the interconnect layer 227, and on the first planarization film 213A. The second planarization film 213B is provided on the protective film 214.

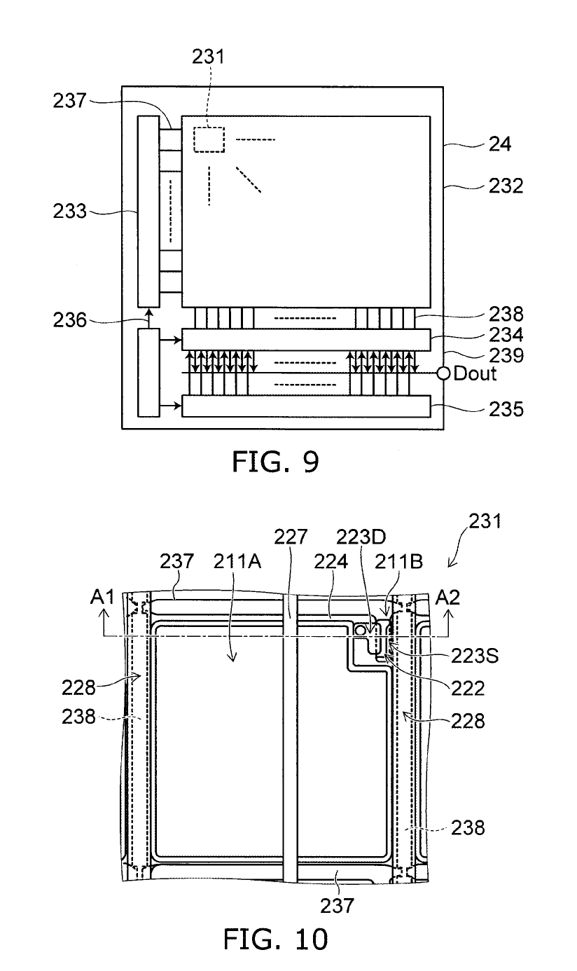

FIG. 9 is a schematic view illustrating a portion of the specimen detection device according to the embodiment.

FIG. 9 shows a functional block of the sensor substrate 200. The sensor substrate 200 includes a pixel unit 232. A peripheral circuit is provided in the sensor substrate 200 in the peripheral region of the pixel unit 232. The peripheral circuit includes, for example, a first scanner 233, a horizontal selector 234, a second scanner 235, and a system controller 236.

The pixel unit 232 includes multiple unit pixels 231. The unit pixel 231 includes the photodiode 211A and the thin film transistor 211B. A pixel drive line 237 and a vertical signal line 238 (the source line) are connected to the unit pixel 231. One end of the pixel drive line 237 is connected to the first scanner 233. For example, the unit pixel 231 corresponds to the detection element 26.

FIG. 10 is a schematic plan view illustrating a portion of the specimen detection device according to the embodiment.

FIG. 10 illustrates the unit pixel 231. In the unit pixel 231, the drain electrode 223D of the thin film transistor 211B (the drive element) is connected to the lower electrode 224 of the photodiode 211A. The source electrode 223S is connected to the vertical signal line 238. The vertical signal line 238 is electrically connected to the thin film transistor 211B.

In the embodiment, for example, the communication between the sensor 22 and the controller 30 and the communication between the light source 10 and the controller 30 may be executed by a wired or wireless method. For example, the controller 30 may be provided at a remote location separated from the sensor 22. The program for at least a portion of the operations of the controller 30 may be stored in a recording medium.

According to the embodiments, a specimen detection device and a specimen detection chip having high precision can be provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, embodiments of the invention are described with reference to specific examples. However, the invention is not limited to these specific examples. For example, one skilled in the art may similarly practice the invention by appropriately selecting specific configurations of components included in the specimen detection chip such as the filter, the sensor, the wall unit, etc., and specific configurations of components included in the specimen detection device such as the light source, the controller, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all specimen detection devices and specimen detection chips practicable by an appropriate design modification by one skilled in the art based on the specimen detection device and specimen detection chips described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

For example, those skilled in the art can suitably modify the above embodiments by addition, deletion, or design change of components, or by addition, omission, or condition change of processes, and such modifications are also encompassed within the scope of the invention as long as they fall within the spirit of the invention.

Other effects led from aspects described in the embodiments are considered to be naturally produced by the invention as long as they are evident from the specification description or could have appropriately been made by a person skilled in the art.

What is claimed is:

1. A specimen detection chip, comprising:
a sensor including a plurality of detection elements;
a wall unit separated from the sensor along a stacking direction; and
a filter provided between the sensor and the wall unit, the filter attenuating a first light of a first peak wavelength and transmitting a light of a wavelength longer than the first peak wavelength,
the plurality of detection elements being arranged at a first pitch along a first direction intersecting the stacking direction,
the wall unit partitioning a plurality of spaces capable of containing a specimen,
the plurality of spaces being arranged at a second pitch along the first direction,
the second pitch being not less than 0.95 times and not more than 1.05 times an integer multiple of the first pitch.

2. The chip according to claim 1, wherein the second pitch is not less than 0.95 times and not more than 1.05 times twice the first pitch.

3. The chip according to claim 1, wherein a length along the first direction of each of the plurality of spaces is not less than a length along the first direction of each of the plurality of detection elements.

4. The chip according to claim 1, wherein
the plurality of detection elements are further arranged at a third pitch along a second direction intersecting the first direction and the stacking direction,
the plurality of spaces are further arranged at a fourth pitch along the second direction, and
the fourth pitch is not less than 0.95 times and not more than 1.05 times an integer multiple of the third pitch.

5. The chip according to claim 4, wherein the fourth pitch is not less than 0.95 times and not more than 1.05 times twice the third pitch.

6. The chip according to claim 4, wherein a length along the second direction of each of the plurality of spaces is not less than a length along the second direction of each of the plurality of detection elements.

7. The chip according to claim 1, wherein one of the plurality of spaces overlaps at least two of the plurality of detection elements when projected onto a plane perpendicular to the stacking direction.

8. The chip according to claim 1, wherein
the wall unit includes a base and a protrusion,
the base is disposed between the protrusion and the filter, and
the plurality of spaces are partitioned by the base and the protrusion.

9. The chip according to claim 8, wherein the base is separated from the filter.
